(19) United States
(12) Patent Application Publication
(10) Pub. No.: US 2023/0308559 A1
(43) Pub. Date: Sep. 28, 2023

(54) FUNCTION EXTENSION APPARATUS, INFORMATION PROCESSING SYSTEM, AND CONTROL METHOD FOR FUNCTION EXTENSION APPARATUS

(71) Applicant: SEIKO EPSON CORPORATION, Tokyo (JP)

(72) Inventor: Masahiko MIZUTA, MATSUMOTO-SHI (JP)

(21) Appl. No.: 18/187,400

(22) Filed: Mar. 21, 2023

(30) Foreign Application Priority Data
Mar. 22, 2022 (JP) 2022-045955

(51) Int. Cl. H04N 1/00

(52) U.S. Cl. CPC H04N 1/00336; H04N 1/00244

(57) ABSTRACT

A function extension server includes a communication control unit configured to acquire a first content file and additional information added to the first content file, a first generator configured to encode the additional information to generate a pattern image, and a second generator configured to add the pattern image to the first content file to generate a second content file. The communication control unit executes transmitting the second content file to a printing server that causes a multifunction peripheral to execute printing.

The present application is based on, and claims priority from JP Application Serial Number 2022-045955, filed Mar. 22, 2022, the disclosure of which is hereby incorporated by reference herein in its entirety.

### BACKGROUND

### 1. Technical Field

The present disclosure relates to a function extension apparatus, an information processing system, and a control method for the function extension apparatus.

### 2. Related Art

There has been known a system that performs printing using the Cloud.

For example, JP-A-2021-184178 (Patent Literature 1) discloses an information processing system including a server and a printing apparatus capable of communicating with the server. The server transmits printing instruction information for instructing printing of teaching material contents and answerer identification information for identifying an answerer who answers the teaching material contents. When receiving the printing instruction information, the printing apparatus generates a print on which the teaching material contents and the answerer identification information are printed.

However, there has been a demand for adding additional information to contents to be printed by the printing apparatus without changing a configuration of an existing server in a system that performs printing and scan using the Cloud.

### SUMMARY

The present disclosure is a function extension apparatus including: an acquiring unit configured to acquire a first content and additional information added to the first content; a first generating unit configured to encode the additional information to generate a pattern image; a second generating unit configured to add the pattern image to the first content to generate a second content; and a first transmitting unit configured to transmit the second content to a printing control apparatus that causes a device to execute printing.

The present disclosure is an information processing system including a function extension apparatus and a printing control apparatus. The function extension apparatus includes: an acquiring unit configured to acquire a first content and additional information added to the first content; a first generating unit configured to encode the additional information to generate a pattern image; a second generating unit configured to add the pattern image to the first content to generate a second content; and a first transmitting unit configured to transmit the second content to the printing control apparatus. The printing control apparatus includes: a converting unit configured to convert the second content into printing data; and a second transmitting unit configured to transmit the printing data to a designated device and cause the designated device to execute printing.

The present disclosure is a control method for a function extension apparatus, the control method executing: acquiring a first content and additional information added to the first content; encoding the additional information to generate a pattern image; adding the pattern image to the first content to generate a second content; and transmitting the second content to a printing control apparatus that causes a device to execute printing.

### BRIEF DESCRIPTION OF THE DRAWINGS

FIG. 1 is a diagram showing a configuration of an information processing system.

FIG. 2 is a block diagram showing an example of configurations of apparatuses configuring the information processing system.

FIG. 3 is a diagram showing an example of a configuration of a content management DB.

FIG. 4 is a diagram showing an example of a configuration of a user management DB.

FIG. 5 is a diagram showing an example of a configuration of a client management DB.

FIG. 6 is a diagram showing an example of a configuration of a device management DB.

FIG. 7 is a sequence chart showing an operation of the information processing system.

FIG. 8 is a sequence chart showing the operation of the information processing system.

FIG. 9 is a flowchart showing an operation of a function extension server.

### DESCRIPTION OF EXEMPLARY EMBODIMENTS

### 1. Configuration of an Information Processing System

An embodiment of the present disclosure is explained below with reference to the accompanying drawings.

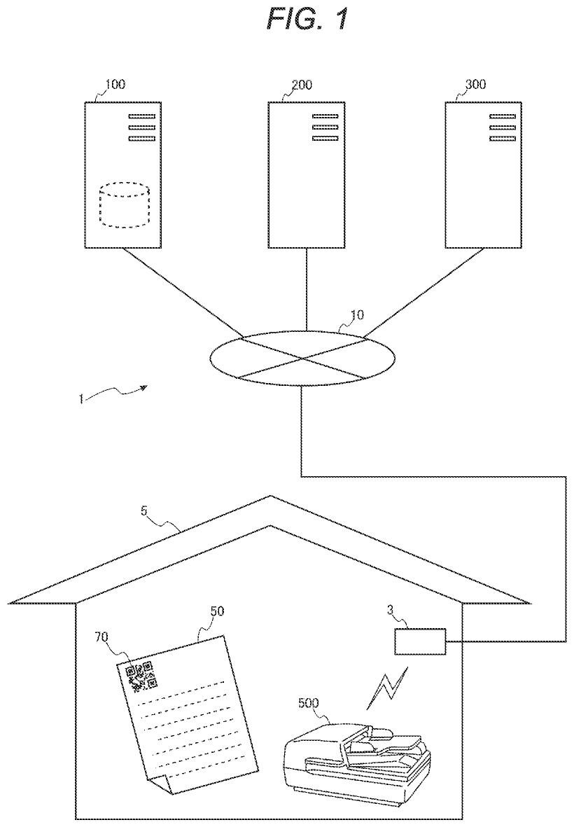

FIG. 1 is a diagram showing a system configuration of an information processing system 1.

The information processing system 1 includes a service provision server 100, a function extension server 200, a printing server 300, and a multifunction peripheral 500. The service provision server 100, the function extension server 200, the printing server 300, and the multifunction peripheral 500 are connected via a network 10. The network 10 includes the Internet, a telephone network, and other communication networks. The function extension server 200 is equivalent to the function extension apparatus and the reading apparatus. The printing server 300 is equivalent to the printing control apparatus. The multifunction peripheral 500 is equivalent to the device.

The service provision server 100 is a server that provides a Web (World Wide Web) service. The Web service provided by the service provision server 100 in this embodiment is a provision service for a first content file. The first content file is, for example, a learning material such as a text or a workbook.

The function extension server 200 is a server that executes functions not implemented in the printing server 300. The function extension server 200 is provided in order to add the functions not implemented in the printing server 300 without changing a configuration of the printing server 300.

The function extension server 200 in this embodiment executes processing for adding a pattern image obtained by encoding additional information to the first content file. The first content file added with the pattern image is referred to as second content file. The additional information is information received from the service provision server 100 and includes, for example, at least one of a user ID for identifying an answerer and a content ID for identifying the first content file that is a teaching material. The user ID is equivalent to the first identification information. The content ID is equivalent to the second identification information.

A case is explained in which the function extension server 200 in this embodiment generates a two-dimensional code such as a QR code as the pattern image. However, the pattern image may be a one-dimensional code or may be a specific character string. QR code is a registered trademark.

The function extension server 200 transmits the generated second content file to the printing server 300.

The function extension server 200 receives a scan file from the printing server 300. The scan file includes scan data generated by the multifunction peripheral 500. The function extension server 200 reads a two-dimensional code added to the scan data and acquires additional information. The function extension server 200 transmits the acquired additional information and the scan file to the service provision server 100.

The printing server 300 and the multifunction peripheral 500 establish continuous connection based on a predetermined real-time communication protocol and execute real-time communication. Examples of the real-time communication protocol include an XMPP (Extensible Messaging and Presence Protocol).

The printing server 300 is a server that provides a Web service. The printing server 300 receives the second content file from the function extension server 200 and converts the received second content file into printing data. The printing server 300 transmits the printing data to the multifunction peripheral 500 designated by the service provision server 100 and causes the multifunction peripheral 500 to execute printing.

The printing server 300 receives scan data scanned by the multifunction peripheral 500. The printing server 300 generates a scan file based on the received scan data. The scan file includes scan data and first destination information. The first destination information is a URL of a Web page provided by the service provision server 100. The printing server 300 transmits the generated scan file to the function extension server 200.

The multifunction peripheral 500 is disposed in a user home 5 of a user having a user contract with a service provider that operates the service provision server 100. The multifunction peripheral 500 is called MFP (Multi Function Peripherals) and includes at least a printing function and a scanner function. The multifunction peripheral 500 may be an apparatus rented from a company or the like that performs rental business or may be an apparatus lent by a school, a cram school, or the like. A wireless router 3 including an access point function is installed in the user home 5. The multifunction peripheral 500 is connected to the network 10 via the wireless router 3.

### 2. Configuration of the Service Provision Server

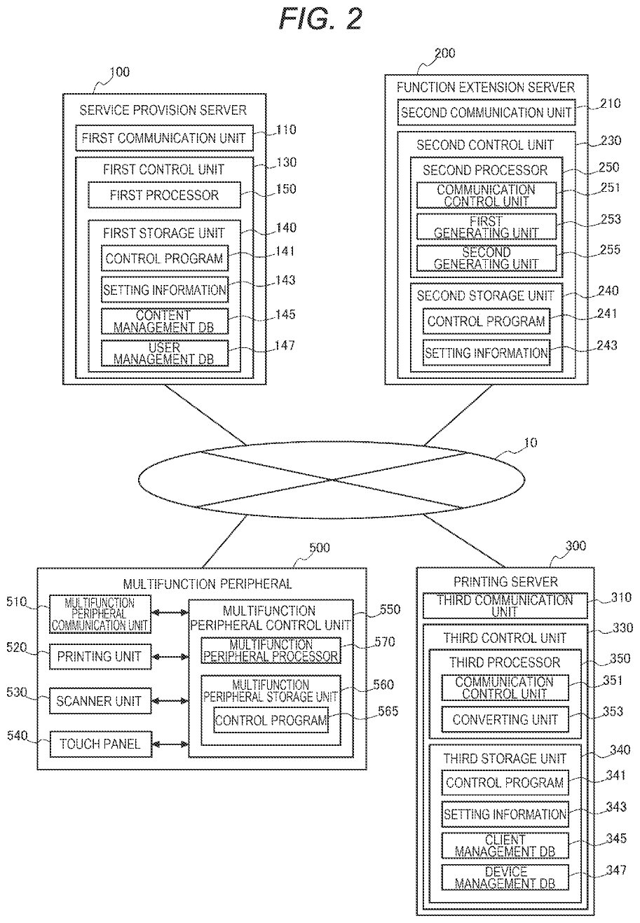

FIG. 2 is a block diagram showing an example of configurations of the apparatuses configuring the information processing system 1.

First, a configuration of the service provision server 100 is explained.

The service provision server 100 includes a first communication unit 110 and a first control unit 130.

The first communication unit 110 includes a communication interface circuit that executes data communication conforming to a communication standard such as an Ethernet. Ethernet is a registered trademark. The first communication unit 110 mutually performs data communication with the function extension server 200 and the printing server 300 via the network 10.

The first control unit 130 is a computer device including a first storage unit 140 and a first processor 150.

The first storage unit 140 includes a RAM (Random Access Memory) and a ROM (Read Only Memory). The first storage unit 140 includes an auxiliary storage device such as a HDD (Hard Disk Drive) or an SSD (Solid State Drive).

The RAM is used as an operation region of the first processor 150.

The ROM stores a control program 141 to be executed by the first processor 150 and various kinds of setting information 143. The setting information 143 includes a client ID and a secret key used for OAuth authentication with the printing server 300. The client ID and the secret key are authentication information issued to the printing server 300.

The auxiliary storage device stores a content management database 145 for managing a first content file and a user management database 147 for managing a user who is provided with a service. In the following explanation, database is abbreviated as DB.

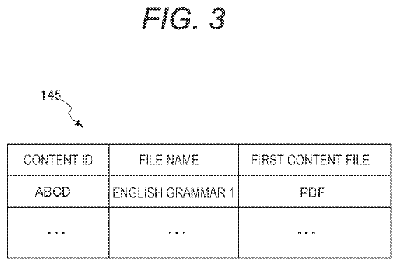

FIG. 3 is a diagram showing an example of a configuration of the content management DB 145.

One record of the content management DB 145 includes a content ID, a file name, and a first content file. The content ID is equivalent to the teaching material identification information.

The content ID is identification information for identifying the first content file. The file name is a file name of the first content file. The first content file is image data in a file format such as a PDF (Portable Document Format) or a JPEG (Joint Photographic Experts Group). The content file may be a document file such as Word or Excel. Word and Excel are registered trademarks.

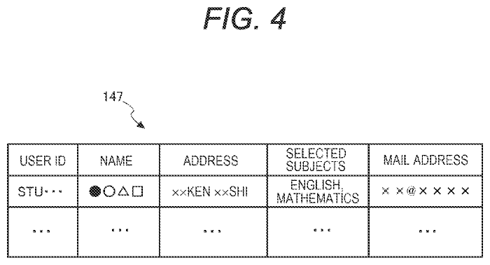

FIG. 4 is a diagram showing an example of a configuration of the user management DB 147.

One record of the user management DB 147 includes, for example, a user ID and a name, an address, selected subjects, and a mail address of a user. The user ID is identification information for identifying a user who uses a Web service provided by the service provision server 100. The mail address is a mail address set in the multifunction peripheral 500 installed in the user home 5 and is an address for uniquely specifying the multifunction peripheral 500.

The first processor 150 is an arithmetic processing device including a processor such as a CPU (Central Processing Unit) or an MPU (Micro-Processing Unit). The first processor 150 may be configured by a single processor or can also be configured by a plurality of processors. The first processor 150 may be configured by an SoC integrated with a part or the entirety of the first storage unit 140 and other circuits. The first processor 150 may be configured by a combination of a CPU that executes a program and a DSP (Digital Signal Processor) that executes predetermined arithmetic processing. Further, all functions of the first processor 150 may be implemented in hardware or may be configured using a programmable device.

The first control unit 130 starts provision of a first content file to the user, for example, when a preset date and time comes.

First, the first control unit 130 accesses the printing server 300 and receives OAuth authentication by the printing server 300.

When succeeding in the OAuth authentication, the first control unit 130 registers destination information in the printing server 300. The destination information is information indicating a destination of a scan file scanned by the multifunction peripheral 500. The destination information is information indicated by a URL. The destination information includes first destination information and second destination information. The first destination information is a URL of a Web page provided by the service provision server 100. The second destination information is a URL of a Web page provided by the function extension server 200. As the first destination information, a different URL is set for each user ID. As the first destination information, a different URL is set for each selected subject. That is, different URLs are set when the scan file scanned by the multifunction peripheral 500 is data obtained by scanning a content print 50 of English and when the scan file scanned by the multifunction peripheral 500 is data obtained by scanning the content print 50 of mathematics.

The first control unit 130 receives an upload URL from the printing server 300. The upload URL is a URL of a Web page provided by the printing server 300 and is information indicating an upload destination to which the first content file is uploaded. The upload URL is equivalent to the second URL.

When receiving the upload URL from the printing server 300, the first control unit 130 transmits an upload request for the first content file to the function extension server 200. The upload request includes additional information added to the first content file, the upload URL received from the printing server 300, a file acquisition URL indicating an acquisition destination of the first content file, and the like. The file acquisition URL is a URL of a Web page provided by the service provision server 100 and is a URL of a Web page from which the first content file uploaded to the printing server 300 can be downloaded. The file acquisition URL is equivalent to the first URL.

### 3. Configuration of the Function Extension Server

Subsequently, a configuration of the function extension server 200 is explained.

The function extension server 200 includes a second communication unit 210 and a second control unit 230.

The second communication unit 210 includes a communication interface circuit that executes data communication conforming to a communication standard such as the Ethernet. The second communication unit 210 mutually performs data communication with the service provision server 100 and the printing server 300 via the network 10.

The second control unit 230 is a computer device including a second storage unit 240 and a second processor 250.

The second storage unit 240 includes a volatile memory such as a RAM and a nonvolatile memory such as a ROM.

The RAM is used as an operation region of the second processor 250.

The ROM stores a control program 241 to be executed by the second processor 250 and various kinds of setting information 243.

The second processor 250 is an arithmetic processing device including a processor such as a CPU or an MPU. The second processor 250 may be configured by a single processor or can also be configured by a plurality of processors. The second processor 250 may be configured by an SoC integrated with a part or the entirety of the second storage unit 240 and other circuits. The second processor 250 may be configured by a combination of a CPU that executes a program and a DSP that executes predetermined arithmetic processing. Further, all functions of the second processor 250 may be implemented in hardware or may be configured using a programmable device.

The second processor 250 includes a communication control unit 251, a first generating unit 253, and a second generating unit 255 as functional blocks. The functional blocks show, as blocks, functions realized by the second processor 250 executing the control program 241. The communication control unit 251 is equivalent to the acquiring unit and the first transmitting unit.

The communication control unit 251 controls the second communication unit 210 and mutually performs data communication with the service provision server 100 and the printing server 300.

For example, the communication control unit 251 receives a upload request from the service provision server 100. The upload request includes additional information. The communication control unit 251 accesses a Web page provided by the service provision server 100 and downloads a first content file from the accessed Web page.

The first generating unit 253 encodes the additional information to generate a pattern image.

The second generating unit 255 adds the pattern image to the first content file to generate a second content file.

When receiving a file upload request from the service provision server 100, the second control unit 230 acquires a file acquisition URL included in the received file upload request. The second control unit 230 accesses a Web page provided by the service provision server 100 indicated by the file acquisition URL. The second control unit 230 downloads a first content file from the accessed Web page.

The second control unit 230 encodes additional information included in the file upload request to generate a two-dimensional code that is an image obtained by encoding the additional information. The second control unit 230 adds the generated two-dimensional code to the first content file to generate a second content file. The second control unit 230 uploads the generated second content file to an address indicated by an upload URL included in the file upload request.

The second control unit 230 receives the scan file from the printing server 300. The scan file includes scan data added with the two-dimensional code and first destination information. The second control unit 230 reads the two-dimensional code and acquires the additional information. The second control unit 230 includes the acquired additional information in a file name of the scan file. For example, the second control unit 230 may include a file name in a part of the file name of the scan file. The second control unit 230 may rewrite the file name of the scan file into additional information. In this embodiment, a case is explained in which the file name of the scan file is rewritten into the additional information. The second control unit 230 uploads the scan file, the file name of which is changed, to a Web page, which is provided by the service provision server 100, indicated by the first destination information.

### 4. Configuration of the Printing Server

Subsequently, a configuration of the printing server 300 is explained.

The printing server 300 includes a third communication unit 310 and a third control unit 330.

The third communication unit 310 includes a communication interface circuit that executes data communication conforming to a communication standard such as the Ethernet. The third communication unit 310 mutually performs data communication with the service provision server 100 and the function extension server 200 via the network 10.

The third control unit 330 is a computer device including a third storage unit 340 and a third processor 350.

The third storage unit 340 includes a RAM, a ROM, and an auxiliary storage device. The RAM is used as an operation region of the third processor 350. The ROM stores a control program 341 to be executed by the third processor 350 and various kinds of setting information 343. The auxiliary storage device stores a client management DB 345 and a device management DB 347.

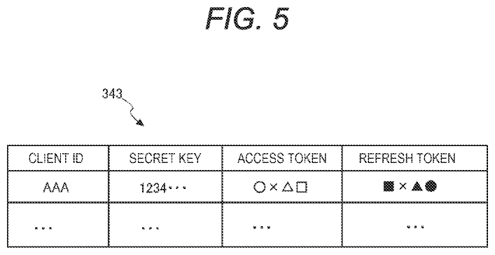

FIG. 5 is a diagram showing an example of a configuration of the client management DB 345.

One record of the client management DB 345 includes a client ID, a secret key, an access token, and a refresh token issued to the service provision server 100.

The client ID is identification information for identifying a client. In this embodiment, the client ID is information for identifying the service provision server 100. The client ID and the secret key are authentication information used for OAuth authentication. The access token is authentication information linked to a client ID registered for each Web service and is also authority information indicating access authority to the printing server 300. The refresh token is authentication information used to acquire the access token again.

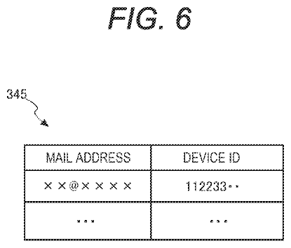

FIG. 6 is a diagram showing an example of a configuration of the device management DB 347.

One record of the device management DB 347 includes a mail address and a device ID. The device ID is fixed identification information for identifying the multifunction peripheral 500 that is a device installed in the user home 5. The mail address is also identification information for identifying the multifunction peripheral 500 that is the device installed in the user home 5 and is identification information that can be changed by the user.

The third processor 350 is an arithmetic processing device including a processor such as a CPU or an MPU. The third processor 350 may be configured by a single processor or can also be configured by a plurality of processors. The third processor 350 may be configured by an SoC integrated by a part or the entirety of the third storage unit 340 and other circuits. The third processor 350 may be configured by a combination of a CPU that executes a program and a DSP that executes predetermined arithmetic processing. Further, all functions of the third processor 350 may be implemented in hardware or may be configured using a programmable device.

The third processor 350 includes a communication control unit 351 and a converting unit 353 as functional blocks. The functional blocks show, as blocks, functions realized by the third processor 350 executing the control program 341. The communication control unit 351 is equivalent to the second transmitting unit.

The communication control unit 351 controls the third communication unit 310 and mutually performs data communication with the service provision server 100, the function extension server 200, and the multifunction peripheral 500.

The converting unit 353 converts a second content file received from the function extension server 200 into printing data described by PDL (Page Description Language)

When receiving an authentication request including a client ID and a secret key, the third control unit 330 performs OAoutH authentication based on the received authentication request. When succeeding in the OAoutH authentication, the third control unit 330 transmits a response including an access token, a refresh token, and a device ID to the service provision server 100.

When receiving a destination registration request from the service provision server 100, the third control unit 330 causes the third storage unit 340 to store destination information included in the received destination registration request. The destination information includes first destination information and second destination information.

When receiving the second content file from the function extension server 200, the third control unit 330 converts the received second content file into printing data described by the PDL. The third control unit 330 transmits the converted printing data to the multifunction peripheral 500 designated by the device ID.

When receiving scan data and selected first destination information from the multifunction peripheral 500, the third control unit 330 generates a scan file including the received scan data and the received first destination information. The third control unit 330 uploads the generated scan file to a Web page, which is provided by the function extension server 200, indicated by a URL of the second destination information.

### 5. Configuration of the Multifunction Peripheral

The multifunction peripheral 500 includes a multifunction peripheral communication unit 510, a printing unit 520, a scanner unit 530, and a multifunction peripheral control unit 550.

The multifunction peripheral communication unit 510 includes, for example, a network card and performs wireless communication by a wireless LAN (Local Area Network). The multifunction peripheral communication unit 510 performs wireless communication by Wi-Fi and is connected to a wireless network constructed by the wireless router 3 including an access point function. Wi-Fi is a registered trademark.

The printing unit 520 includes an inkjet head that ejects ink to a printing medium and forms dots, a carriage that causes the inkjet head to perform scan in a scanning direction, a carriage driving motor that drives the carriage, a conveying unit that conveys the printing medium, an ink supply unit that supplies the ink to the inkjet head, and the like. The printing unit 520 ejects the ink from a nozzle of the inkjet head and forms dots on a printing surface of the conveyed printing medium to perform printing on the printing medium according to control of the multifunction peripheral control unit 550.

The scanner unit 530 radiates light emitted by a light source on, for example, a document placed on a not-shown document stand, reads characters and images recorded on the document, and outputs image data obtained by the reading to the multifunction peripheral control unit 550. The multifunction peripheral control unit 550 performs data processing such as RGB conversion and compression processing on the image data input from the scanner unit 530 to generate scan data.

The multifunction peripheral control unit 550 is a computer device including a multifunction peripheral storage unit 560 and a multifunction peripheral processor 570.

The multifunction peripheral storage unit 560 includes a volatile memory such as a RAM and a nonvolatile memory such as a ROM.

The RAM is used as an operation region of the multifunction peripheral processor 570. The ROM stores a control program 565 to be executed by the multifunction peripheral processor 570.

The multifunction peripheral processor 570 is an arithmetic processing device including a processor such as a CPU or an MPU. The multifunction peripheral processor 570 may be configured by a single processor or can also be configured by a plurality of processors. The multifunction peripheral processor 570 may be configured by an SoC integrated with a part or the entirety of the multifunction peripheral storage unit 560 and other circuits. The multifunction peripheral processor 570 may be configured by a combination of a CPU that executes a program and a DSP that executes predetermined arithmetic processing. Further, all functions of the multifunction peripheral processor 570 may be implemented in hardware or may be configured using a programmable device.

When receiving printing data from the printing server 300, the multifunction peripheral control unit 550 controls the printing unit 520 to print an image based on the received printing data on paper. The multifunction peripheral 500 outputs the content print 50. A two-dimensional code 70 is printed on the content print 50.

The user picks up the content print 50 and writes answers to questions described on the content print 50. When finishing writing the answers on the content print 50, the user touches a touch panel 540 and instructs the multifunction peripheral 500 to perform scan.

When the scan is instructed, the multifunction peripheral control unit 550 acquires a list of destination information from the printing server 300 and causes the touch panel 540 to display the acquired list of destination information. The list of destination information displayed on the touch panel 540 is a list of first destination information. In the list of first destination information, for example, URLs corresponding to the first destination information and display names indicating transmission destinations are displayed in association with each other. As the display names, a transmission destination of answers to English questions and a transmission destination of answers to mathematics questions are displayed.

The user refers to the display of the touch panel 540 and selects the first destination information set as a destination of answers.

For example, when a second content file is mathematics questions and the content print 50 is a print on which the second content file is printed, the user selects the first destination information set as an upload destination of answers to the mathematics questions. When the second content file is English questions and the content print 50 is a print on which the second content file is printed, the user selects the first destination information set as an upload destination of answers to the English questions.

When the first destination information is selected by touch on the touch panel 540, the multifunction peripheral control unit 550 controls the scanner unit 530 to start scan. The multifunction peripheral control unit 550 transmits scan data generated by the scan to the printing server 300.

When receiving the scan data from the multifunction peripheral 500, the third control unit 330 of the printing server 300 generates a scan file. The scan file includes the received scan data and the first destination information selected by the user.

The third control unit 330 uploads the generated scan file to a Web page indicated by the second destination information. The Web page indicated by the second destination information is a Web page provided by the function extension server 200.

### 6. Operation of the Information Processing System

Subsequently, an operation of the information processing system 1 is explained.

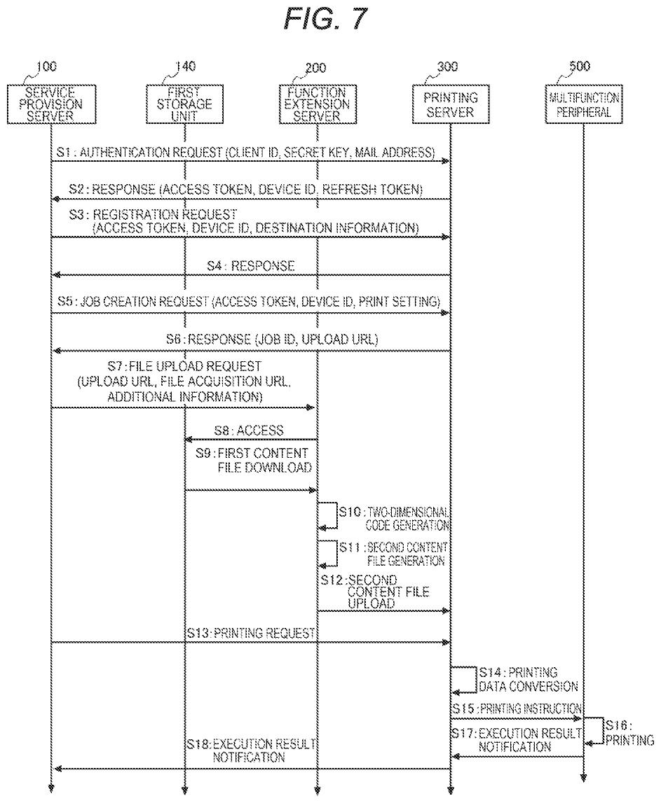

FIG. 7 is a sequence chart showing the operation of the information processing system 1.

First, the first control unit 130 of the service provision server 100 transmits an authentication request to the printing server 300 (step S1). The authentication request includes a client ID, a secret key, and a mail address set in the multifunction peripheral 500.

The third control unit 330 of the printing server 300 receives the authentication request and authenticates the received authentication request. The third control unit 330 determines whether the received client ID and the received secret key are registered in the client management DB 345 and authenticates the authentication request.

When succeeding in the authentication of the authentication request, the third control unit 330 issues an access token and a refresh token and registers the issued access token and the issued refresh token in the client management DB 345. The third control unit 330 refers to the device management DB 347 and acquires a device ID associated with the mail address. The third control unit 330 returns a response including the issued access token and the issued refresh token and the acquired device ID to the service provision server 100 (step S2).

Subsequently, the first control unit 130 of the service provision server 100 transmits a destination registration request including the access token and the device ID received in step S2 and destination information to the printing server 300 (step S3). The destination information includes first destination information and second destination information. The third control unit 330 receives the registration request and causes the third storage unit 340 to store the first destination information and the second destination information included in the registration request. The third control unit 330 transmits a response indicating that the registration request is successful to the service provision server 100 (step S4).

Subsequently, the first control unit 130 generates a job creation request and transmits the generated job creation request to the printing server 300 (step S5). The job creation request includes the access token and the device ID received in step S2 and print setting. The print setting is print setting for the content print 50 to be printed by the multifunction peripheral 500 and is setting of, for example, a color or black and white, duplex printing, and a paper size.

The third control unit 330 generates a response to the received job creation request and transmits the generated response to the service provision server 100 (step S6). The response includes a job ID for identifying a job and an upload URL.

Subsequently, the first control unit 130 transmits a file upload request to the function extension server 200 (step S7). The file upload request includes an upload URL, a file acquisition URL, and additional information.

When receiving the file upload request, the second control unit 230 of the function extension server 200 accesses the file acquisition URL included in the received file upload request (step S8). The second control unit 230 downloads a first content file from the accessed file acquisition URL and acquires the first content file (step S9).

When acquiring the first content file, the second control unit 230 acquires the additional information included in the file upload request received from the service provision server 100 in step S7. The second control unit 230 generates a two-dimensional code including the acquired additional information (step S10). The second control unit 230 attaches the generated two-dimensional code to the first content file to generate the second content file (step S11). The second control unit 230 accesses a Web page of the printing server 300 indicated by the upload URL and uploads the second content file (step S12).

Subsequently, the first control unit 130 transmits a printing request to the printing server 300 (step S13). The printing request includes an access token, a device ID, a job ID, and the like.

When receiving the printing request from the service provision server 100, the third control unit 330 of the printing server 300 converts, according to the print setting received in step S5, the second content file into printing data described by the PDL (step S14). The third control unit 330 transmits a printing instruction including the converted printing data to the multifunction peripheral 500 corresponding to the device ID (step S15).

When receiving the printing instruction from the printing server 300, the multifunction peripheral control unit 550 executes printing of the printing data included in the received printing instruction (step S16) and transmits an execution result notification indicating whether the execution of the printing is successful or unsuccessful to the printing server 300 (step S17).

The third control unit 330 of the printing server 300 causes the third storage unit 340 to store the received execution result notification in association with a processing ID and transmits the received execution result notification to the service provision server 100 (step S18).

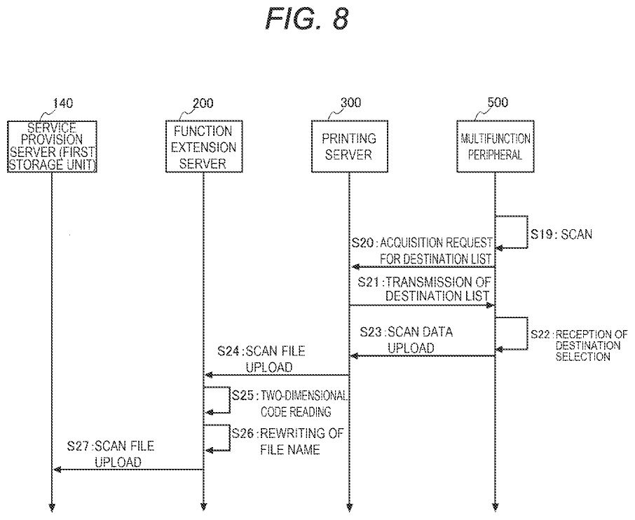

FIG. 8 is a sequence chart showing an operation for uploading scan data from the multifunction peripheral 500 to the service provision server 100.

Subsequently, an operation from scanning, with the multifunction peripheral 500, the content print 50 on which answers are written until transmitting scan data generated by the scan to the service provision server 100 is explained.

When printing data is printed by the multifunction peripheral 500 and the content print 50 is output, the user reads questions described on the content print 50 and writes answers to the questions.

After writing answers to all the questions, the user places, on the document stand of the multifunction peripheral 500, the content print 50 on which the answers are written and touches the touch panel 540 to instruct the multifunction peripheral 500 to perform scan (step S19).

When receiving the instruction to scan (step S19), the multifunction peripheral control unit 550 transmits an acquisition request for a destination list to the printing server 300 (step S20). The third control unit 330 transmits a destination list associated with the multifunction peripheral 500 to the multifunction peripheral 500 (step S21). The multifunction peripheral control unit 550 causes the touch panel 540 to display the received destination list (step S22). The destination list displayed on the touch panel 540 is a list of the first destination information. Destinations for each of subjects such as mathematics and English are displayed as a list.

When receiving selection of destination information by touch on the touch panel 540 (step S22), the multifunction peripheral control unit 550 causes the scanner unit 530 to scan the content print 50 placed on the document stand. The multifunction peripheral control unit 550 uploads scan data generated by the scan to the printing server 300 (step S23).

When receiving the scan data from the multifunction peripheral 500, the third control unit 330 of the printing server 300 generates a scan file. The scan file includes the received scan data and the first destination information selected by the user. The third control unit 330 uploads the generated scan file to the Web page, which is provided by the function extension server 200, indicated by the URL of the second destination information (step S24).

When receiving the scan file from the printing server 300, the second control unit 230 of the function extension server 200 acquires scan data from the received scan file. The second control unit 230 reads a two-dimensional code of the acquired scan data and acquires additional information (step S25). The second control unit 230 changes a file name of the scan file based on the acquired additional information (step S26). The second control unit 230 changes the file name of the scan file to the acquired additional information. The second control unit 230 uploads the scan file, the file name of which is changed, to a Web page, which is provided by the service provision server 100, indicated by a URL of the first destination information (step S27).

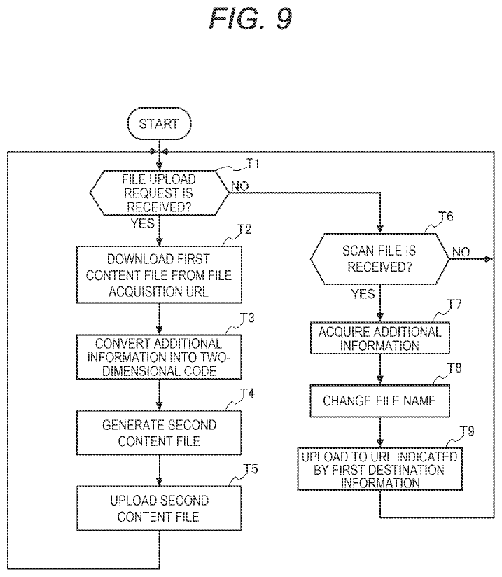

FIG. 9 is a flowchart showing an operation of the function extension server 200.

The operation of the function extension server 200 is explained with reference to the flowchart of FIG. 9.

First, the second control unit 230 determines whether a file upload request is received from the service provision server 100 (step T1).

When receiving the file upload request (YES in step T1), the second control unit 230 acquires a file acquisition URL from the received file upload request. The second control unit 230 accesses a Web page of the printing server 300 indicated by the acquired file acquisition URL and downloads a first content file (step T2).

Subsequently, the second control unit 230 extracts additional information included in the file upload request and converts the extracted additional information into a two-dimensional code (step T3). The second control unit 230 adds the converted two-dimensional code to the first content file acquired in step T2 to generate a second content file (step T4). The second control unit 230 acquires an upload URL from the file upload request, accesses a Web page of the printing server 300 indicated by the acquired upload URL, and uploads the second content file (step T5).

When not receiving the file upload request (NO in step T1) but receiving a scan file (YES in step T6), the second control unit 230 extracts scan data included in the received scan file. The second control unit 230 reads a two-dimensional code included in the extracted scan data to acquire additional information (step T7).

Subsequently, the second control unit 230 changes a file name of the scan file based on the acquired additional information (step T8). The second control unit 230 accesses a Web site indicated by a URL of first destination information and uploads the scan file, the data name of which is changed (step T9).

When not receiving a scan file (NO in step T6), the second control unit 230 returns to the determination in step T1.

### 7. Effects

As explained above, the function extension server 200 in this embodiment includes the communication control unit 251, the first generating unit 253, and the second generating unit 255.

The communication control unit 251 acquires a first content file and additional information added to the first content file.

The first generating unit 253 encodes the additional information to generate a pattern image.

The second generating unit 255 adds the pattern image to the first content file to generate a second content file.

The communication control unit 251 transmits the second content file to the printing server 300 that causes the multifunction peripheral 500 to execute printing.

With this configuration, it is possible to add the pattern image obtained by encoding the additional information to the first content file to generate the second content file and transmit the generated second content file to the printing server 300. That is, it is possible to cause the multifunction peripheral 500 to print the pattern image including the additional information. Accordingly, it is possible to easily realize addition of functions not implemented in the printing server 300 without changing the configuration of the printing server 300.

The communication control unit 251 of the function extension server 200 receives a first URL indicating a download destination of the first content file and the additional information and downloads the first content file from a Web page indicated by the first URL.

With this configuration, it is possible to cause the function extension server 200 to acquire the first content file.

The communication control unit 251 of the function extension server 200 receives a second URL indicating an upload destination of the second content file, accesses a Web page indicated by the second URL, uploads the second content file, and transmits the second content file to the printing server 300.

With this configuration, it is possible to cause the printing server 300 to receive the second content file added with the pattern image.

The first content file is a teaching material content. The additional information includes at least one of a user ID for identifying an answerer of the first content file and a content ID for identifying the first content file.

With this configuration, it is possible to add at least one of identification information for identifying the answerer and identification information for identifying the first content file to the second content file.

The information processing system 1 includes a reading apparatus that reads a pattern image and acquires additional information.

With this configuration, it is possible to read the pattern image and acquire the additional information.

The embodiment explained above only indicates an aspect of the present disclosure. Modifications and applications are optionally possible within the scope of the present disclosure.

For example, a plurality of URLs may be set as the first destination information included in the scan file. For example, a URL indicating an upload destination of the scan file in the case in which the function extension server 200 succeeds in reading a two-dimensional code and acquires additional information and a URL indicating an upload destination of the scan file in the case in which the function extension server 200 fails in reading the two-dimensional code and fails in acquiring the additional information may be registered as the first destination information.

In the embodiment explained above, a case is explained in which the function extension server 200 operates as the reading apparatus that reads a two-dimensional code and acquires additional information. However, a server operating as the reading apparatus may be separately provided or a function of the reading apparatus may be provided in the service provision server 100.

The configurations of the service provision server 100, the function extension server 200, the printing server 300, and the multifunction peripheral 500 are an example and specific implementation forms of the service provision server 100, the function extension server 200, the printing server 300, and the multifunction peripheral 500 are not particularly limited. That is, hardware individually corresponding to the units does not always need to be implemented. It is naturally possible to adopt a configuration in which one processor executes a program to realize the functions of the units. A part of functions realized by software in the embodiment may be realized by hardware. A part of functions realized by hardware in the embodiment may be realized by software.

For example, the step units of the operations shown in the sequence charts of FIGS. 7 and 8 are divided according to main processing contents in order to facilitate understanding of the operations of the apparatuses of the information processing system 1. The present disclosure is not limited by a way of division and names of the step units. The operations may be divided into, according to processing contents, a larger number of step units and may be divided such that one step unit includes a larger number of kinds of processing. The order of the steps may be changes as appropriate in a range in which the gist of the present disclosure not hindered. The same applies to the flowchart showing the operation of the function extension server 200 shown in FIG. 9.

When the control method for the function extension apparatus is realized using a computer included in the function extension server 200, a program to be executed by the computer can also be configured in a form of a recording medium or a transmission medium for transmitting the program. As the recording medium, a magnetic or optical recording medium or a semiconductor memory device can be used. Specific examples of the recording medium include portable or stationary recording media such as a flexible disk, a HDD (Hard Disk Drive), a CD-ROM, a DVD, a Blu-ray Disc, a magneto-optical disk a flash memory, and a card-type recording medium. The recording medium may be a nonvolatile storage device such as a RAM, a ROM, or a HDD that is an internal storage device included in a server apparatus. Blu-ray is a registered trademark.

What is claimed is:

1. A function extension apparatus comprising:
an acquiring unit configured to acquire a first content and additional information added to the first content;
a first generator configured to encode the additional information to generate a pattern image;
a second generator configured to add the pattern image to the first content to generate a second content; and
a first transmitter configured to transmit the second content to a printing control apparatus that causes a device to execute printing.

2. The function extension apparatus according to claim 1, wherein the acquiring unit receives to acquire a first URL indicating a download destination of the first content and the additional information and downloads and acquires the first content from a Web page indicated by the first URL.

3. The function extension apparatus according to claim 1, wherein
the acquiring unit receives a second URL indicating an upload destination of the second content, and
the first transmitter accesses a Web page indicated by the second URL, uploads the second content, and transmits the second content to the printing control apparatus.

4. The function extension apparatus according to claim 1, wherein
the first content is a teaching material content, and
the additional information includes at least one of first identification information for identifying an answerer of the first content and second identification information for identifying the first content.

5. The function extension apparatus according to claim 1, further comprising a reading apparatus configured to read the pattern image and acquire the additional information.

6. An information processing system comprising a function extension apparatus and a printing control apparatus, wherein
the function extension apparatus includes:
an acquiring unit configured to acquire a first content and additional information added to the first content;
a first generator configured to encode the additional information to generate a pattern image;
a second generator configured to add the pattern image to the first content to generate a second content; and
a first transmitter configured to transmit the second content to the printing control apparatus, and
the printing control apparatus includes:
a converter configured to convert the second content into printing data; and
a second transmitter configured to transmit the printing data to a designated device and cause the designated device to execute printing.

7. A control method for a function extension apparatus, the control method executing:
acquiring a first content and additional information added to the first content;
encoding the additional information to generate a pattern image;
adding the pattern image to the first content to generate a second content; and
transmitting the second content to a printing control apparatus that causes a device to execute printing.
